(19) United States
(12) Patent Application Publication
(10) Pub. No.: US 2009/0177575 A1
(43) Pub. Date: Jul. 9, 2009

(54) SYSTEM AND METHODS FOR ACQUIRING AN INTEREST IN REAL PROPERTY

(75) Inventor: Stuart J. HAYS, Hillsborough, CA (US)

Correspondence Address: IPxLAW Group LLP, 95 South Market Street, Suite 570, San Jose, CA, 95113, US

(73) Assignee: RHINO HOLDINGS, INC., San Francisco, CA (US)

(21) Appl. No.: 12/406,668

(22) Filed: Mar. 18, 2009

Related U.S. Application Data
(62) Division of application No. 11/173,343, filed on Jul. 1, 2005, now abandoned.
(60) Provisional application No. 60/588,027, filed on Jul. 15, 2004.

(51) Int. Cl. G06Q 40/00; G06Q 30/00

(52) U.S. Cl. 705/37

(57) ABSTRACT

Methods and systems for implementing investment options on a real property. An owner of the real property may sell a Call option that gives the owner a consideration in exchange for an option to purchase the property at a strike price at some point in the future, wherein the strike price is set to a percentage of the initial fair market value of the property. The Call option may also give the owner the right to participate in the net appreciation of the property upon sale. The owner may purchase a Put option that gives the owner a stop-loss in the event of a market downturn or the depreciation of the property's value. By placing a Collar, a bundled Call and Put option, around the real property, the owner may diversify his/her exposure to market downturns in exchange for a piece of the upside.

### CROSS-REFERENCE TO RELATED APPLICATIONS

This application is a divisional of U.S. patent application Ser. No. 11/173,343, entitled “SYSTEM AND METHODS FOR ACQUIRING AN INTEREST IN REAL PROPERTY”, filed Jul. 1, 2005, which claims priority to U.S. Provisional Application Ser. No. 60/588,027 filed on Jul. 15, 2004 both disclosures of which are hereby incorporated by reference.

### FIELD OF THE INVENTION

The present invention relates to real estate investments, more particularly, to systems and methods for implementing investment options on real properties.

### BACKGROUND OF THE INVENTION

Mortgages, which are liens on land and improvements thereon given as security for the payments of debts, are time-honored instruments for financing the purchase of real estate. A mortgage for most people is not only the biggest financial decision but also is a personal decision due to everyone's different situation including age, job status, and the like. Consequently, a highly developed market exists for various types of mortgages, such as, traditional, reverse, shared-appreciation and shared-equity mortgages.

Typically, lenders of traditional mortgages are compensated with interest on the principal amount extended. Fundamental aspects of traditional real estate mortgage lending may: i) create a large prospective financial burden for borrowers in the form of total interest paid over the life of instrument that normally exceeds the original principal extended, and ii) subject lenders and homeowners to risks stemming from, among other factors, variations in future interest rates and fluctuations in the real estate market. These fundamental aspects of traditional real estate mortgages have become firmly entrenched, with little flexibility to the homeowners and secured lenders in the mortgage plan approach.

A reverse mortgage is a special type of loan that can be used by people 62 and older to convert their equity in their homes into cash. Reverse mortgages may tend to be more costly than traditional mortgages because they are rising-debt loans. The interest may be added to the principal loan balance each month, and consequently, the total amount of interest owed may increase significantly with time as the interest compounds. In addition, reverse mortgages may use up all or some of the equity in a home, which may leave fewer assets for the homeowner and his/her heirs. Also, as in the case of traditional mortgages, reverse mortgages may offer little flexibility on the changes in the market value of the property to the homeowners and secured lenders, and fail to account for the anticipated “future-value” of the home.

A shared appreciation mortgage (SAM) is a fixed-rate, fixed-term loan that can extend for a period up to 30 years. A purchaser of a SAM plan, typically a homeowner of a real property, may pay interest at a lower rate than market interest rates while the lender may take a proportionate share of the capital appreciation on the property over the period of the mortgage. SAM plans may be traded actively at a time when the pundits forecast static house price or low appreciation only in the years ahead. However, if house prices rise much higher than forecast and the costs are translated into an equivalent rate of interest, the purchasers may realize that they have paid a high cost. A major drawback of a typical SAM plan is that it could not be transferred to a new property, which may restrict the purchaser's freedom to sell the house if his/her circumstances change.

As the existing mortgage plans may suffer from flaws in that they offer little flexibility to the homeowner and mortgage lenders in the event of market changes, the homeowners and lenders may be subject to high financial risks upon significant market changes, such as the burst of a real estate bubble. The bursting of a real estate bubble may matter to individual investors in two aspects: 1) it can have a broad detrimental impact on the economy and the stock market, and 2) it can significantly hurt the average household balance sheet. Thus, there is a need for investment options or plans for the homeowners and mortgage lenders that may provide hedge against real estate market changes and improve the stability and predictability of real estate markets throughout the country.

### SUMMARY OF THE INVENTION

The present invention provides methods, systems and computer readable media for implementing investment options on real property. The owner of a parcel of real property (or, “owner”) may be offered a Call option that gives the owner a consideration in exchange for an option to purchase the parcel of real property (or, “property”) at a strike price at some point in the future. The Call option may also give the owner the right to participate in the net appreciation of the property upon sale of the property. In addition, the owner may be offered a Put option that gives the owner a stop loss in the event of a market downturn or the depreciation of the property's value.

In one aspect of the present invention, there are provided methods and systems for transacting a Call option on a property of an owner. On a pre-determined grant date for the Call option, an initial fair market value (IFMV) of the property is determined by one or more appraisers or a sale of the property. Also, a strike price is set at a percentage of the initial fair market value. Then, the owner selects one of the Call options offered by the offeror, wherein each Call option may have variables including a term, a period during which the Call may be exercised by the offeror entity, a percentage of the IFMV given to the owner on the grant date and a degree of profit sharing allocated for the owner. If the owner decides to buy a financial product that removes a portion of equity from the property or chooses to retain his/her ownership beyond the term, it may then be required that the owner buy out the selected Call option from the offeror. If the owner chooses to sell the property during the term, the sale of the property is arranged and compensation for the early termination is recovered from the owner. If the owner yields his/her ownership or the property upon expiration of the term, or in the event that a certain limited circumstance, such as death or permanent relocation of the owner, occurs before the term expires, the selected Call option is exercised as per the option contract terms.

In another aspect of the present invention, methods and systems are provided for transacting a Put option on a property of an owner. On a selected grant date of the Put Option, an initial fair market value of the real property is determined by one or more appraisers or a sale of the property. Then, the owner buys a Put option offered by offeror, wherein the Put option locks-in a strike value of the property at a preset percentage of the initial fair market value. The Put option may have a term, an exercise period and a put grant price. If the owner chooses to retain his/her ownership beyond the term or decides to sell the property before the term expires, the offeror may terminate the Put option. If the owner is willing to yield his/her ownership upon expiration of the term, or in the event that a certain limited circumstance, such as death or permanent relocation of the owner, occurs before the term expires, the Put option is exercised. The owner or the guardian of the owner may exercise the Put option by requiring the offeror to purchase the real property at the strike price or by getting from the offeror the difference between the strike price and the current fair market value. Alternatively, the Put option can be exercised by the owner upon the expiration of the term, and the value of the property determined by an appraisal.

These and other features, aspects and advantages of the present invention will become better understood with reference to the following drawings, description and claims.

### BRIEF DESCRIPTION OF THE DRAWINGS

FIG. 1 shows a flow chart illustrating a process for facilitating a Call option transaction on a property in accordance with one embodiment of the present invention.

FIG. 2 shows a flow chart illustrating a process for transacting a Call option on a property in accordance with another embodiment of the present invention.

FIG. 3 shows a flow chart illustrating a process for facilitating a Put option transaction on a property in accordance with still another embodiment of the present invention.

FIG. 4 shows a flow chart illustrating a process for transacting a Put option on a property in accordance with yet another embodiment of the present invention.

FIG. 5 illustrates a typical computer system that may be employed in accordance with the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

It must be noted that, as used herein and in the appended claims, the singular forms “a”, “and”, and “the” include plural referents unless the context clearly dictates otherwise. Thus, for example, reference to “an owner of a parcel of real property” includes one or more owners who hold the title to the real property and equivalents thereof known to those skilled in the art, and so forth.

### DEFINITIONS

RHINO is one or more types of options on a parcel of real property (Real estate Home INvestment Options) including a Put option and a Call option. A Rhino can be offered to the owner by an offeror, and the Call option may be exercised by the holder, who may be the same as the offeror, or a different entity if the offeror has transferred ownership of the option. The Put option may be purchased and exercised by the owner.

A RHINO Collar (or, “Collar”), as used herein, refers to a RHINO product including a bundled Put and Call option.

A grant date, as used herein, refers to a date when the owner of a property sells a Call option (not an obligation) and/or buys a Put option on the property.

The fair market value (FMV) or a piece of property, as used herein, refers to a price at which a property would change hands between a willing buyer and a willing seller, neither being under any compulsion to buy or to sell and both have reasonable knowledge of relevant facts.

A current fair market value (CFMV), as used herein, refers to a fair market value at the time of the exercise of an option. The CFMV may be determined by a qualified appraiser, or by actual sale of the property to a third party.

An initial fair market value (IFMV), as used herein, refers to a fair market value of the property on a grant date.

A grant price, as used herein, refers to a percentage of the IFMV paid to an owner on a grant date of a Call option.

A put grant price, as used herein, can be any amount, and it the term can be expressed as a percentage of the IFMV paid to RHINO on a grant date of a Put option.

A strike price, as used herein, refers to the price at which an option can be exercised, typically locked in to a predetermined percentage of the property's initial fair market value.

An exercise period, as used herein, refers to a period, during which the exercise of the underlying option maturing at the expiration of the term may be performed. For example, the exercise period may be set to sixty or ninety days prior to or following expiration of the term.

Broadly, the present invention provides an investment option on a property that may allow the owner of the property, banks, and other investors to purchase and/or sell real estate options on the property. Unlike existing approaches that may not take into account the anticipated “future-value” of the property and fail to protect against the downturns in the real estate market, the present invention provides a Call option that may give the owner a form of consideration, such as a performance of needed repairs or home improvement, a payment of liabilities or liens, a down payment, and living expenses, in exchange for an option by the option offeror to purchase the property at a strike price at some predetermined point in the future. By selling the Call option, the owner may also receive the right to participate in the net appreciation of the property upon sale thereof. The present invention also provides the owner with an opportunity to purchase a Put option that may give the owner a stop-loss in the event of a market downturn or the depreciation of the property's value.

By placing a Collar around residential real properties, the owner of a high value property (“homeowner”), may use a variety of Collar strategies to protect the net worth. Collar strategies may involve borrowing or hedging against a position in a manner that creates a more diversified investment portfolio. The homeowners who are heavily overweighed in real estate may use the Collars to diversify their exposure to market downturns in exchange for a lesser piece of the upside. Banks and other lending institutions may benefit from the Collars due to the fixed minimum fair market value of a particular property resulting from the Put option.

Examples of customers who may benefit from use of the method of the present invention include; 1) seniors who may wish to lock in their equity or otherwise preserve their current asset value in real property, 2) seasoned homeowners who may wish to make repairs or otherwise improve their structure with little to no short-term cost or increase in monthly payments, and 3) first-time homebuyers struggling to raise their down payment. RHINO Collars may give RHINO customers the right to sell a Call option on their homes. Hereinafter, for simplicity, the term “owner” of real property refers to one or more legal entities which may have an ownership interest in a parcel or long-term lease in a piece of real estate, and preferably, the term “owner” will refer to at most two natural persons or their trusts who have such an ownership interest.

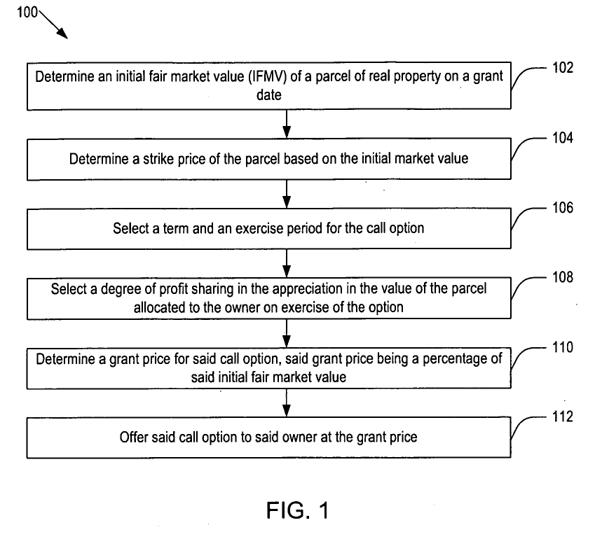

Referring now to FIG. 1, FIG. 1 is a flow chart shown at 100 that illustrates a process for facilitating a Call option transaction on a property in accordance with one embodiment of the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The process may begin in a state 102. In the state 102, the initial fair market value (IFMV) of the property on a grant date may be determined by qualified appraisers or by the recent transaction price for the property if the owner acquired the property in the recent past. In order to ensure fair and equitable treatment of all parties involved in RHINO transactions, as well as to discourage and offer remedies in case of fraud relating to property appraisal, all inspections of properties for purposes of valuation may be conducted by appraisers who are recognized experts in the field and are properly bonded or otherwise insured. In order to prevent bias on the part of the appraisers towards the offeror of the Call options, the homeowner may select their specific appraiser from a list of qualified appraisers for their specific appraisal. As an example, the Call option offeror may have the property re-inspected and appraised by two other appraisers from the same list and the appraised fair market value may be the average of the three appraisals. Next, based on the IFMV of the property, the owner and the offeror of the Call option may agree upon a strike price in a state 104, where the strike price may be a preset percentage of the IFMV. Then, the process may advance from the state 104 to a state 106.

Each of the Call options offered by the offeror may include as many as three variables, or more; including a stated term of the option, a grant price as of the date of offer of the option, and a degree of profit sharing allocated to the owner. The degree of profit sharing allocated to the owner may represent the percentage of the owner's right to participate in the appreciated value of the property between the grant date and the date of sale of the property (or the date on which the owner buys out the Call option, as will be explained later). Thus, the appreciated value of the property will be the difference between the initial fair market value and the current fair market value (CFMV) on the date of sale or the date when the owner buys out the Call option.

TABLE 1
Exemplary Call options offered by an Offeror

| | | A degree of profit sharing |
|---|---|---|
| Term | Amount paid to the owner on | allocated for the owner upon |
| (years) | the grant date (grant price) | sale of the property |
| 10 | 16% of IFMV on grant date | 10% of post grant profit |
| 10 | 13% of IFMV on grant date | 30% of post grant profit |
| 10 | 10% of IFMV on grant date | 50% of post grant profit |
| 7 | 15% of IFMV on grant date | 10% of post grant profit |
| 7 | 11% of IFMV on grant date | 40% of post grant profit |
| 5 | 14% of IFMV on grant date | 10% of post grant profit |
| 5 | 11% of IFMV on grant date | 30% of post grant profit |

Table 1 shows exemplary Call options offered by an offeror, wherein three columns represent the three variables; the term, grant price and degree of profit sharing allocated for the owner upon sale of the property (or, equivalently, post-grant profit), respectively. The values in Table 1 have been determined to maintain a predetermined (in this case, approximately 22%) annual rate of (investment) return to the option holder, assuming an annual appreciation of the underlying property of 7% during the term. As the values in Table 1 can vary depending on the term, annual rate of return and appreciation rate in the real estate market, it should be apparent to those of ordinary skill that the present invention may be practiced with other suitable combinations of the values. In the states 106, 108 and 110, the three variables of the Call options may be selected. Also, in the state 106, the exercise period of the Call option may be selected. Upon determination/selection of the three variables, the process may advance to a state 112.

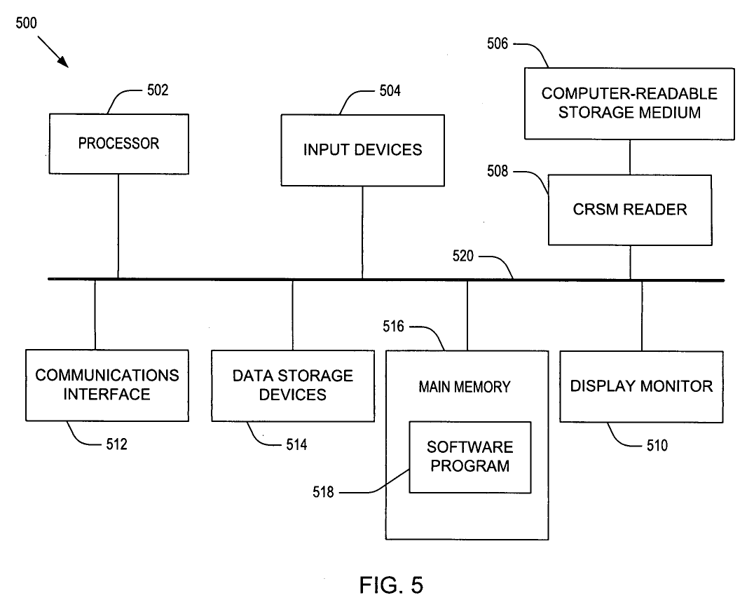

In the state 112, the Call options may be offered to the owner of the property. If the owner selects one of the Call options, the owner may receive the grant price specified in the selected Call option. It is noted that the states 102-112 may be facilitated with the use of a computer system 500 (FIG. 5) as will be explained later.

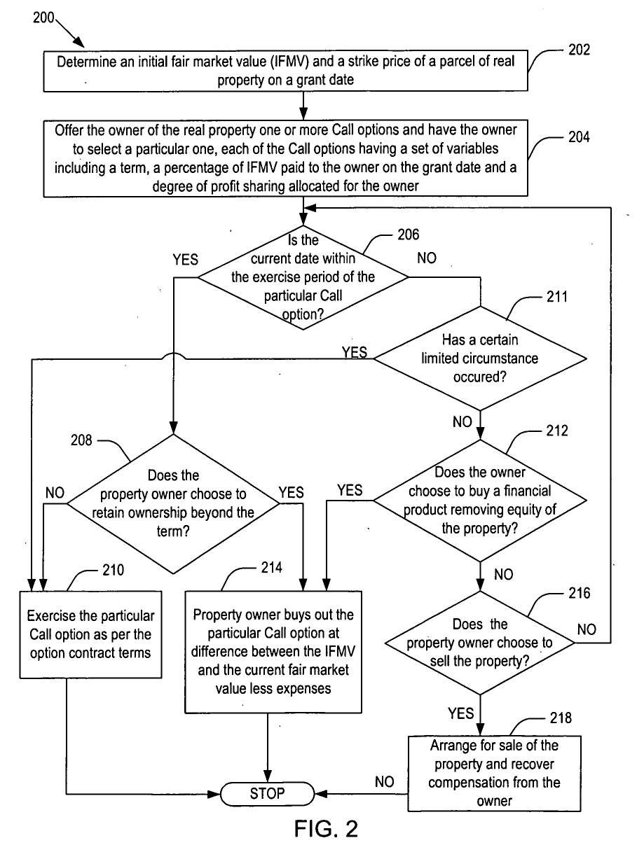

Referring now to FIG. 2, FIG. 2 is a flowchart shown at 200 that illustrates a process for transacting a Call option on a property in accordance with another embodiment of the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The process may begin in a state 202. In the state 202, the initial fair market value (IFMV) of the property on a grant date may be determined in the same manner as described in state 102. Then, in the state 204, the owner of the property may select one of the Call options (or, equivalently, products) presented by the Call offeror on the grant date. Each Call option may have an exercise period and three variables described in connection with the states 104, 106, 108 and 110. The owner may select and sell the selected Call option (but not the obligation) that may give an option holder(s) a right to purchase the property at the strike price at some point in the future. As consideration for the right of the offer holder to buy the property in the future for the strike price, a grant price, expressed as a percentage of the IFMV, may be paid to the owner on the grant date. The option holder entity may then record its interest in the property with the county recorder in the county in which the property is located. Then, the process may proceed to a decision block 206.

In the decision block 206, a determination may be made as to whether the current date is within the exercise period of the Call option selected by the owner. Upon negative answer to the decision block 206, the process may proceed to another decision block 211. In the decision block 211, a determination may be made as to whether a certain limited circumstance, such as death or permanent relocation of the owner, has occurred before the term expires. Upon affirmative answer to the decision block 211, the process may proceed to a state 210.

In the state 210, the Call option may be exercised by the option holder as per the option contract terms stipulated in the Call option. The option holder may exercise the Call option by arranging for sale of the property at the current fair market value and paying the owner the profit sharing allocated for the owner (or, equivalently post grant profit), less expenses. The Call option may be exercisable within 90 days from the time the owner ceases to occupy the property, for example, either by reason of death, permanent relocation to an assisted-living facility or nursing home, or the absence from the property for a pre-determined period, such as 60 or 90 days (which may be presumed to be permanently vacating the property). Either the owner, the guardian for the owner, or the administrator of the property may notify the option holder of the intent to vacate the property. In the event that the option holder does not elect to exercise the Call option, then the Call option may run-with-the-land, until the end of the Call option term. In an alternative embodiment, the Call option may be exercisable within a predetermined period, such as sixty or ninety days prior to or following expiration of the term.

If there are determined to be no specified circumstances in the state 211, the process may proceed to a decision block 212. In the decision block 212, the process may determine whether the owner chooses to buy a financial product, such as home equity loan or second mortgage, which removes a portion of equity from the property. A RHINO Collar including the Call option may be structured in such a manner that the owner is allowed to refinance his/her mortgage in order to obtain a lower interest rate or different mortgage product, but not allowed to remove equity from the property. This flexibility may protect the option holder from the owner removing equity from the property that would otherwise flow to the value of the option. The rationale for this is that if there is a downturn in property values after an owner has extracted a portion of equity from his/her property, then a situation can result by which the option holder is deprived of monies which would otherwise would have flowed to the option holder absent the refinancing. If the owner chooses to take out a second mortgage or home equity loan before the term expires, the process may proceed from the state 212 to a state 214.

In the state 214, it may be required for the owner to buy out the Call option by paying the difference between the initial fair market value and the current fair market value on the buyout date, less the profit sharing allocated to the owner, brokerage fee and the optional cost of appraisal if the option offeror has paid for the cost of appraisal.

Upon negative answer to the decision block 212, the process may proceed to another decision block 216. In the decision block 216, the process may determine whether the owner chooses to sell the property before the term expires. If the owner chooses to sell the property, the process may advance to a state 218.

In the state 218, the holder's option to purchase the property may accelerate and the option holder may have the right to purchase (or list) the property at the strike price before the expected term of the option, meaning there may not have been sufficient time for the anticipated appreciation in value of the property over the full term of the option to have taken place. In order to ensure the option holder receives the benefit of its bargain with the owner, the holder may arrange for sale of the property at the current fair market value and recover compensation from the owner for the lack or anticipated appreciation in value of the property by attenuating or eliminating the degree of profit sharing allocated for the owner. The amount of compensation to be paid by the owner as a consequence of early termination may equal a sum of an optional cost of appraisal and an amount of monies owed by the owner, wherein the amount of monies may be determined to maintain the option holder's investment return at a preset percentage, preferably 22% per annum, and optionally adjusted for a broker's fee.

In the event that the elimination of the owner's profit sharing may not be sufficient to maintain the holder's expected return on its investment, the remainder of the compensation owed by the owner may be satisfied from the owner's equity in the property at issue as per the terms of the contract stipulated in the Call option. Compensation recovered from early-terminations of the Call option may be an approximation of the option holder's loss of revenue, time and expense to the option offeror or holder—they are not penalties or other methods to increase the option holder's revenue above and beyond the bargained for agreement with the owner.

If the process determines that the owner chooses not to sell the property in the state 216, the process may proceed back to the state 206. If it is determined in the state 206 that the current date is within the exercise period, the process may proceed to a decision block 208.

In the block 208, the process may determine if owner chooses to retain ownership of the property beyond the term of the Call option. Upon affirmative answer to the decision block 208, the process may proceed to a state 214. In the state 214, it may be required for the owner to buy out the Call option as explained previously. In all likelihood, the owners wishing to retain ownership beyond option term may simply refinance their homes or properties and use a portion of the proceeds to pay off their RHINO Calls. If the owner is either unwilling or unable to pay, then RHINO may institute proceedings to enforce the option contract.

If process determines in the state 208 that the owner decides to terminate ownership of the property on the expiration of the term, the process may proceed from the state 208 to the state 210. In the state 210, the Call option may be exercised as per the option contract terms stipulated in the Call option. The option holder may exercise the Call option by arranging for sale of the property at the current fair market value and paying the owner the profit sharing allocated for the owner (or, equivalently post grant profit) less expense.

As explained above, the Call option may give the owner the right to participate in the net appreciation of the property. In the event that the owner breaches any of their covenants, representations or warranties contained in the option agreement, including but not limited to failing to cooperate with the new owners of the property or failing to vacant the property in a timely manner, or damaging the property in excess of normal wear and tear then, that certain portion of the owner's net appreciation shall be forfeited and directed to the option holder or option offeror by the escrow agent. The escrow agent may reimburse the option holder or option offeror for any and all costs of legal and other fees and expenses to enforce the option holder's rights, including but not limited to, the removal or ouster of the owner or occupants upon the end of the option period or to cover such damages to the property as the case may be.

In addition to the Call options explained in connection with FIGS. 1 and 2, RHINO may also provide the owner with an opportunity to purchase a Put option. The Put option is the owner's option to sell the property back to the offeror at the strike price, giving the owner a stop-loss in the event of a market downturn or the depreciation of the property's value. The Put option may lock in the strike price at a preset percentage of the initial fair market value. Also, the Put option may be exercised by the owner or by the owner's trusts or beneficiaries under certain limited circumstances, such as death of the owner.

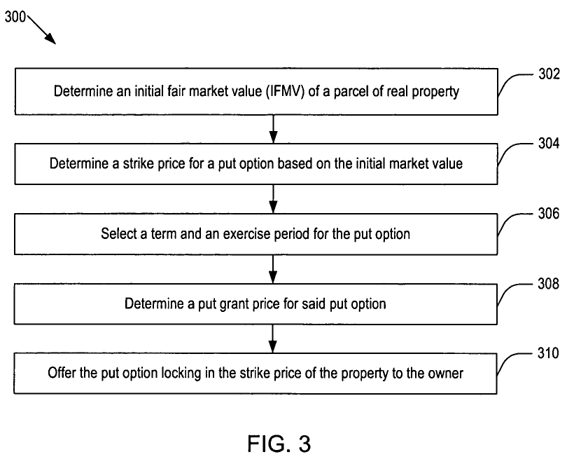

FIG. 3 is a flow chart shown at 300 illustrating a process for facilitating a Put option transaction on a property in accordance with still another embodiment of the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The process may begin in a state 302. In the state 302, the initial fair market value (IFMV) of the property on a grant date may be determined. The procedures to determine the IFMV are explained in connection with the operational block 102. Next, in a state 304, the strike price of the property for a Put option may be set to percentage, preferably between about 90% and 98% of the IFMV, and more preferably about 95% of the IFMV.

As in the case of the Call option described in FIG. 1, the Put option may have a term and an exercise period. In a state 306, the term and an exercise period of the Put option may be selected. Then, the process may advance to a state 308.

In the state 308, a put grant price of the property for the Put option may be determined. The put grant price may be paid by the owner to RHINO on the grant date as consideration for the right of the owner to sell the property in the future for the strike price. Then, in a state 310, the owner of the property may be offered the opportunity to purchase a Put option that locks in the strike price for the property. The owner may select a RHINO Collar that includes a bundled Call and Put option. In such a case, the transaction of the Put option may be processed in tandem with the corresponding Call option. Also, as in the case of the Call option described in FIG. 1, the states 302-310 may be facilitated with the use of a computer system 500 (FIG. 5) as will be explained later.

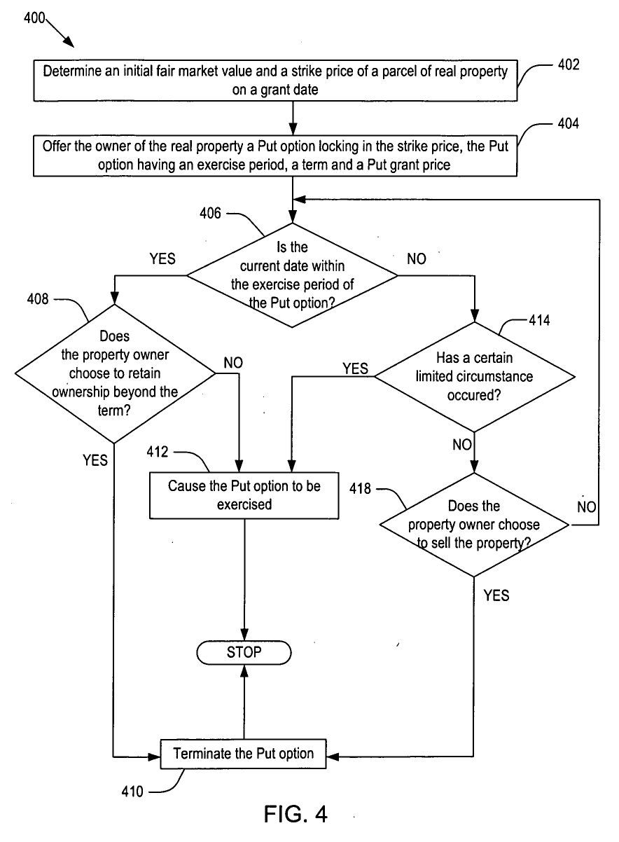

FIG. 4 is a flowchart shown at 400 that illustrates a process for transacting a Put option on a parcel of real property in accordance with yet another embodiment of the present invention. It will be appreciated by those of the ordinary skill that the illustrated process may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like.

The process may begin in a state 402. In the state 402, the initial fair market value (IFMV) of the property on a grant date may be determined. The procedures to determine the IFMV are explained in connection with the operational block 102 (FIG. 1). In this state, the strike price of the property may be also determined. The strike price of the property may be set to percentage, preferably between about 90% and 98% of the IFMV, and more preferably about 95% of the IFMV. Then, the process may advance from the state 402 to a state 404.

In the state 404, the owner of the property may be offered the opportunity to purchase a Put option that locks in the strike price for the property. As in the case of the Call option described in FIGS. 1 and 2, the Put option may have a term and an exercise period. The Put option may also include a put grant price to be paid by the owner to RHINO. The owner may select a RHINO Collar that includes a bundled Call and Put option. In such a case, the transaction of the Put option may be processed in tandem with the corresponding Call option. Next, the process may proceed to a decision block 406.

In the decision block 406, a determination may be made as to whether the current date is within the exercise period of the Put option. Upon negative answer to the decision block 406, the process may proceed to another decision block 414. In the decision block 414, a determination may be made as to whether a certain limited circumstance, as explained in connection with the state 211 (FIG. 2), occurs before the term expires. Upon affirmative answer to the decision block 414, the process may proceed to a state 412.

In the state 412, the Put option may be exercised, i.e., the offeror may be required by the owner to purchase (or list for sale) the property at the current fair market value. In an alternative embodiment, the offeror may be required to pay the owner the difference between the strike price and the current fair market value. The Put option may be exercisable within 90 days from the time the owner ceases to occupy the property, either by reason of death, permanent relocation to an assisted-living facility or nursing home, or the absence from the property for a pre-determined period, such as 60 or 90 days. Either the owner, the guardian for the owner, or the administrator of the property may notify the offeror of the intent to vacate the property. In an alternative embodiment, the offeror may simply require that the owner have the current fair market value of the property determined by an appraisal.

In the event that the owner does not elect to exercise the Put option, then the Put option may run-with-the-land until the end of the Put option term. In an alternative embodiment, the Put option may be exercisable within sixty or ninety days before or after the expiration of the term.

If the process cannot find any listed circumstances in the state 414, the process may proceed to a decision block 418.

In the state 418, the process may determine if the owner chooses to sell the property before the term expires. If the owner chooses to sell the property, the process may proceed to the state 410 terminating the Put option. If it is determined that the owner chooses not to sell the property before the term expires, the process may proceed back to the state 406.

If the decision block 406 determines that the current date is within the exercise period of the Put option, the process may proceed to a decision block 408. In the block 408, the process may determine if the owner chooses to retain ownership of the property beyond the term of the Put option. If the owner chooses not to retain ownership, the process may proceed to the state 412 causing the Put option to be exercised. If the owner decides to yield the ownership on the expiration of the term in the state 408, the process may proceed to the state 410 terminating the Put option. In an alternative embodiment, the owner may have the value of the property determined by an appraisal, and proceed with exercise of the option in state 112.

To preserve the viability of the owner's downside protection, the offeror of options to a multiplicity of owners may use a portion of its reserves to fund various hedging strategies including, but not limited to: shorting locally focused residential real estate investment trusts; investing in counter-cyclical commodities and equities; and/or outsourcing these responsibilities by purchasing insurance policies to cover against a market down.

FIG. 5 is a schematic diagram of a typical computer system shown at 500 that may be employed in accordance with the present invention. Depending on its configuration, the computer system may be employed as a desktop computer, a server computer, or an appliance, for example and may have less or more components to meet the needs of a particular application. As illustrated, the computer system may include a processor 502, such as those from the Intel Corporation or Advanced Micro Devices, for example. The computer system may have one or more buses 520 coupling its various components. The computer system may also include one or more input devices 504 (e.g., keyboard, mouse), a computer-readable storage medium (CRSM) 506, a CRSM reader 508 (e.g., floppy drive, CD-ROM or DVD drive), a display monitor 510 (e.g., cathode ray tube, flat panel display), a communication interface 512 (e.g., network adapter, modem) for coupling to a network, one or more data storage devices 514 (e.g., hard disk drive, optical drive, FLASH memory), and a main memory 516 (e.g., RAM). Software programs, such as a program 518 for calculating an initial fair market value and a strike price of the property, may be stored in the computer-readable storage medium 506 and read into the data storage devices 514 or main memory 516 as illustrated in FIG. 5. Likewise, other program data, such as the variables (Table 1) of the Call and Put options offered by RHINO, may be stored in CRMS 506 and read into the data storage 514 or main memory 516.

The input devices 504 may be used to input data into the computer system 500, wherein the input data may include fair market values of the property estimated by one or more appraisers. Then, using the input data, the program data of the Collars and the software program 518 read into the main memory 516, the processor 502 may determine the initial fair market value (IFMV) and strike price of the property. As one of ordinary skill in the programming art can implement without undue experimentation the software program 518, a detailed description as to the implementation of the software program 518 is not given in the present document. It is also noted that those of ordinary skill can implement various software programs without undue experimentation that can carry out one or more steps in the processes 100, 200, 300 and 400.

It should be understood, of course, that the foregoing relates to exemplary embodiments of the invention and that modifications may be made without departing from the spirit and scope of the invention as set forth in the following claims.

What is claimed is:

1. A method for an entity to acquire value based on capital appreciation in real property, comprising:
determining an initial fair market value of real property;
paying pecuniary consideration to the owner of the real property;
receiving a promise of future performance by the owner;
recording a memorialization of the promise with a county recorder in a county in which the real property is located; wherein
the pecuniary consideration paid to the owner is based at least on the initial fair market value;
the owner has no duty to pay interest related to the paid pecuniary consideration;
the promise of future performance by the owner is in a written call option contract for the real property; and
the future performance by the owner includes providing the entity with valuable consideration at least equivalent to a predetermined portion of capital appreciation of the real property at a time of the future performance.

2. The method of claim 1 wherein the real property is owner occupied residential real property and the entity has no title or estate in the real property prior to the time of the future performance.

3. The method of claim 1 wherein terms of the call option contract provide that the owner can fully discharge the future performance by paying the entity an amount of pecuniary consideration least the substantial equivalent of the predetermined portion of the capital appreciation at the time of the discharge, whereby the owner discharges any duty to transfer a title or estate in the real property to the entity.
